(19) United States
(12) Patent Application Publication
(10) Pub. No.: US 2017/0059513 A1
(43) Pub. Date: Mar. 2, 2017

(54) HYBRID ION-SENSITIVE FIELD-EFFECT TRANSISTOR

(71) Applicant: INTERNATIONAL BUSINESS MACHINES CORPORATION, Armonk, NY (US)

(72) Inventors: ALI AFZALI-ARDAKANI, OSSINING, NY (US); BAHMAN HEKMATSHOARTABARI, WHITE PLAINS, NY (US); GHAVAM SHAHIDI, POUND RIDGE, NY (US)

(21) Appl. No.: 14/841,640

(22) Filed: Aug. 31, 2015

(51) Int. Cl. G01N 27/414

(52) U.S. Cl. CPC G01N 27/4145

(57) ABSTRACT

Ion-sensitive field-effect transistors including channel regions of inorganic semiconductor material and organic gate junctions are provided for detecting biological materials or reactions within an electrolyte. The transistors may include self-assembled monolayers to passivate a surface of the inorganic semiconductor material. Bio-sensing material is immobilized by the self-assembled monolayers for use in bio-detection. A back-gate electrode is optionally employed.

### FIELD

The present disclosure relates to thin-film electronic device structures and technology and, more particularly, to field-effect transistors including both inorganic and organic materials and the use of such transistors in the field of bio-sensors.

### BACKGROUND

Sensors have been developed for sensing or measuring various types of physical and chemical parameters. Ion sensitive field effect transistor (ISFET) based sensors are commonly employed for sensing biochemical reactions. Changes in conductance within a test solution can be detected from changes in transistor conductance. For example, an ISFET sensor may be employed to detect the release of hydrogen as the byproduct of DNA base pairing. ISFET technology presents various challenges, one of which is flicker (1/f) noise that is the dominant noise source in field-effect transistors. As the transistor dimensions are shrunk to improve the array density, the flicker noise intensity increases, hence limiting the resulting signal-to-noise ratio and scaling up the array density.

A conventional double-gate (DG) ISFET is shown in FIG. 7. The device 60 includes a semiconductor substrate 61 on which source and drain regions 62, 63 are formed. A functionalization layer 66 including a specific functional group 67 is formed on a dielectric layer 64 on the substrate 61. A gate dielectric layer 65 is provided between the semiconductor substrate and a back-gate electrode 68, such as a metal layer. The threshold voltage of the bottom transistor is measured to determine whether a targeted species has attached to the specific functional group and thereby to the functionalization layer.

Organic materials offer several advantages in bio-sensor applications, including bio-responsiveness, bio-compatibility, low-cost/low-temperature processing, softness, and good electrical interfacing with biological materials. There are, however, drawbacks to organic bio-sensing devices, including possible degradation of the organic material as a result of exposure to biological material. Moreover, the performance of organic transistors is generally inferior to that of inorganic transistors and may not be satisfactory for signal processing in some applications.

### BRIEF SUMMARY

In accordance with the principles discussed herein, ion-sensitive field-effect transistors and methods and systems relating to such transistors are provided.

A biosensor provided in accordance with a first aspect includes a doped inorganic semiconductor layer including a channel region and source and drain regions operatively associated with the channel region. An organic passivation layer directly contacts a top surface of the channel region of the doped inorganic semiconductor layer. A functionalization layer including bio-sensing material is bound to the organic passivation layer.

An exemplary fabrication method includes obtaining a substrate including a doped inorganic semiconductor layer having a channel region including a top surface, forming source and drain regions on the substrate, forming an organic passivation layer directly contacting the top surface of the channel region of the doped inorganic semiconductor layer, and forming a functionalization layer including bio-sensing material on the organic passivation layer.

An exemplary method of detecting the presence of targeted species or sensing biochemical reactions includes obtaining a biosensor including a doped inorganic semiconductor layer including a channel region, source and drain regions operatively associated with the channel region, an organic passivation layer directly contacting a top surface of the channel region of the doped inorganic semiconductor layer, and a functionalization layer including bio-sensing material bound to the organic passivation layer. The functionalization layer is contacted with an electrolyte and a voltage potential is applied to a gate electrode within the electrolyte. The method further includes detecting a shift in threshold voltage of the biosensor.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

Substantial beneficial technical effects are provided by the exemplary structures and methods disclosed herein. For example, one or more embodiments may provide one or more of the following advantages:
Relatively high signal to noise ratio;
Low-temperature processing compatible with flexible and low-cost substrates;
Use of environmentally and chemically stable materials feasible.

These and other features and advantages of the disclosed methods and structures will become apparent from the following detailed description of illustrative embodiments thereof, which is to be read in connection with the accompanying drawings.

### BRIEF DESCRIPTION OF THE DRAWINGS

FIG. 1 shows a schematic illustration of an inorganic substrate including a hydrogen-terminated top surface;

FIG. 2 shows the substrate of FIG. 1 with a self-assembled monolayer thereon;

FIG. 3 is a schematic illustration of an exemplary biosensor;

FIG. 4 is a schematic illustration of a hybrid ISFET for sensing target species;

FIGS. 5A-5E show an exemplary process for forming a functionalized self-assembled monolayer on a silicon substrate;

FIG. 6 is a graph showing the threshold voltage shift of an exemplary ISFET, and

FIG. 7 is a schematic illustration of a conventional DG ISFET.

### DETAILED DESCRIPTION

Thin-film hybrid biosensors are disclosed that include crystalline, inorganic channels and organic gate junctions. Such biosensors combine the advantages of organic materials in bio-sensing with the high performance associated with inorganic devices. Ion-sensitive field-effect transistors (ISFET) including inorganic channels and organic gate junctions are employed in exemplary biosensors. The ISFETs may optionally include back gates disposed on a transistor surface opposite from the surface of the semiconductor channel.

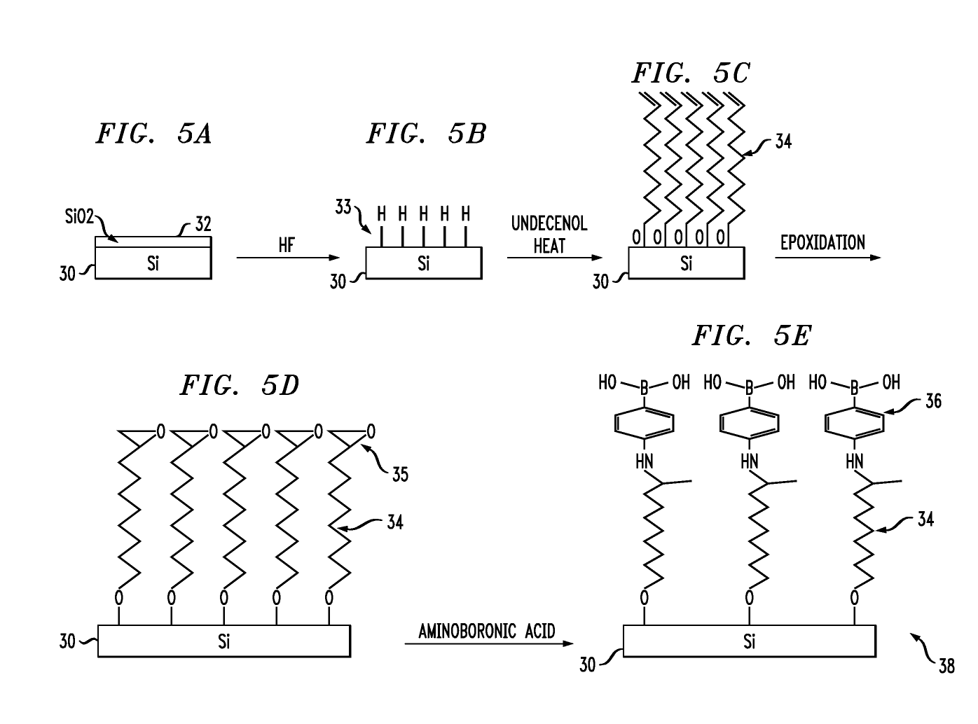

FIG. 1 shows an exemplary crystalline silicon substrate layer 10 having a hydrogen-terminated top surface. Such a surface is obtained after subjecting the substrate to immersion in hydrofluoric acid, as discussed further below with reference to the process flow shown in FIGS. 5A-5E. The inorganic substrate layer is n-type in this exemplary embodiment. As used herein, “n-type” refers to the addition of impurities that contribute free electrons to an intrinsic semiconductor. In a silicon containing substrate, examples of n-type dopants, i.e. impurities, include but are not limited to antimony, arsenic and phosphorous. The doped inorganic semiconductor layer can be formed as a continuous layer as shown during fabrication of a semiconductor-on-insulator (SOI) wafer. Ion implantation can alternatively be employed following SOI substrate wafer fabrication to form the doped layer. The doped substrate layer 10 is between 20 nm-1 μm in thickness in one or more embodiments. The doping concentration of the layer 10 is between 10¹⁵ to 10¹⁹ cm⁻³ in one or more embodiments where the layer is a crystalline silicon layer. In some exemplary embodiments, the doped layer has a thickness of 32 nm and a doping concentration of 5×10¹⁹cm⁻³. The term “crystalline” as employed herein encompasses both monocrystalline and polycrystalline forms of the inorganic semiconductor material employed to form the substrate layer 10. In addition to silicon, Group IV materials such as Ge, SiGe, SiC, SiGeC or GeC may be used for forming the inorganic semiconductor layer of the resulting biosensor. In other embodiments, the inorganic semiconductor substrate is comprised of III-V or II-VI compound semiconductors.

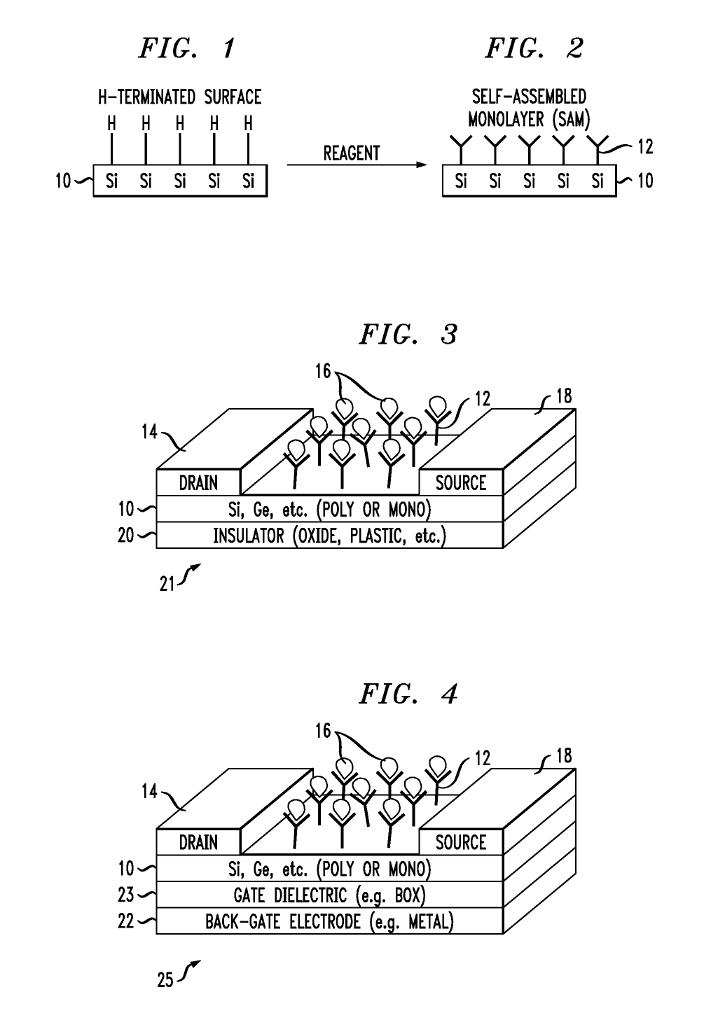

Referring to FIG. 2, an organic passivation layer 12 is formed directly on the top surface of the doped inorganic semiconductor substrate layer 10. In some embodiments, a self-assembled organic monolayer (SAM) forms the organic passivation layer. This layer saturates the dangling bonds on the surface of the inorganic semiconductor substrate layer 10. The self-assembled monolayer is an environmentally and chemically stable material in one or more embodiments, such as a long-chain alcohol (1-dodecanol, for example) or thiol.

A device 21 for sensing biomolecules as shown in FIG. 3 includes a substrate wherein the doped, inorganic semiconductor substrate layer 10 adjoins an electrically insulating layer 20. The electrically insulating layer is an oxide layer in some embodiments. Plastic or other insulating materials could alternatively be employed. In one or more embodiments, the electrically insulating layer 20 is a buried oxide (BOX) layer. The insulating layer 20 in an exemplary embodiment is between 5-200 nm, but may also be thicker or thinner for some applications. The electrically insulating layer 20 in one exemplary embodiment is comprised of silicon dioxide, though other buried insulators such as boron nitride (BN) and aluminum oxide (Al₂O₃) may alternatively be employed in some embodiments. The device further includes drain and source regions 14, 18. In some embodiments, the drain and source regions comprise metal (for example, aluminum deposited by thermal evaporation) formed on heavily doped n⁺ silicon regions with N_{D} of larger than 10²⁰ cm⁻³. Ion implantation of the inorganic semiconductor layer may be employed for forming the heavily doped n+ regions while the regions of the inorganic semiconductor substrate layer 10 to be used as the channel regions are protected by a mask, leaving the channel regions at lower doping levels than the source/drain regions. Alternatively, ohmic contacts are formed on the active areas of the n-type semiconductor substrate layer. The exposed surfaces of the active areas are cleaned to remove the native oxide using, for example, hydrofluoric acid. Contact metal is deposited using one of several known techniques such as chemical vapor deposition (CVD), evaporation and sputtering. The contact metal may be deposited within a patterned photoresist layer (not shown) that is subsequently removed. A low workfunction metal such as erbium or magnesium can be used to form ohmic contact to n-type silicon. Due to the high cost of rare and precious metals, in some embodiments, a thin layer of these materials (e.g. <3 nm) is deposited followed by a less expensive metal such as aluminum, chrome, titanium, copper or combinations thereof. The deposited contacts are optionally subjected to annealing. In some embodiments, the optional annealing process may form a silicide.

An exemplary double-gated biosensor 25 is shown in FIG. 4. The same reference numerals employed in FIG. 3 are used to designate similar elements. The biosensor in the exemplary embodiment includes a back-gate electrode 22 and a gate dielectric layer 23 between the inorganic substrate layer 10 and the electrode. In one example, the back-gate electrode 22 is comprised of aluminum. In another example, the carrier substrate (e.g. silicon) serves as the back-gate electrode 22, which may further include a metal coating (e.g. aluminum) to facilitate electrical access to the back-gate electrode 22. The gate dielectric layer is formed from silicon dioxide having a thickness between one hundred and three hundred nanometers (100-300 nm) in some embodiments, though other dielectric materials and/or thicknesses may alternatively be employed. A buried oxide (BOX) layer forms the gate dielectric layer in some embodiments.

FIGS. 5A-5E show an exemplary process flow that results in the formation of a functionalized self-assembled monolayer on silicon for bio-sensing, it being appreciated that the principles disclosed are applicable to formation of monolayers on substrates other than silicon. Referring to FIG. 5A, the exposed surfaces of a silicon substrate 30 are cleaned to remove the native oxide 32 using, for example, hydrofluoric acid or an oxide buffer etch to form a hydrogenated silicon surface 33 as shown in FIG. 5B. The resulting structure is immersed in a long-chain alcohol, in this case 12-dedecene-1-ol and heated at 90-120° C. for bonding to the hydrogenated silicon substrate. A self-assembly 34 of alkene-terminated chain is thereby formed on the silicon substrate, as shown in FIG. 5C. Epoxidation of the terminal double bonds of the self-assembled layer forms a highly reactive epoxy functional group 35, as schematically illustrated in FIG. 5D. Epoxidation of alkenes using oxidizing agents such as peroxides/peracids is a known process familiar to those of skill in the art to obtain functional groups, namely epoxides. A desirable functional group 36 is attached with the epoxy group 35 to obtain the structure 38 schematically illustrated in FIG. 5E. In one exemplary embodiment, the epoxy group is reacted with aminophenyl boronic acid to form a self-assembled monolayer with terminal boronic acid groups that are suitable for the immobilization and sensing of sugars. Other reagents can be reacted with the epoxy groups to obtain analyte-specific reagents. For example, for sodium ion sensing, an amine-functionalized crown ether can be employed for immobilization of certain proteins. In some embodiments, the epoxy groups are treated with Biotin through its carboxylic functionality to obtain a biotin-terminated SAM capable of binding with proteins such as streptavidin. The functionalized monolayers identified herein are considered exemplary and not limiting. The source/drain regions 14, 18 of the devices 21, 25 are formed prior to formation of the organic material on the surfaces of the channel regions of the inorganic semiconductor layers 10 of the devices where such formation requires relatively high temperature steps such as epitaxial growth, doping diffusion, silicidation, or other processes as known in the art. The order of formation of these elements may not be critical in some embodiments.

The operation of single-gate biosensing devices, such as shown in FIG. 3, is well known to the art. The targeted species present within an electrolyte that attach to the functionalized surface of the device have an electrical charge that changes the surface potential of the channel and therefore the threshold voltage (the minimum gate-to-source voltage differential that is needed to create a conducting path between the source and drain terminals) of the transistor. A gate electrode is provided within the electrolyte containing the targeted species. The changes in the electrical characteristics of the device caused by the attached species can be detected. The type and surface density of the functionalization layer determine the type(s) of species to be attracted and attached to the channel surface.

Double-gated structures, such as the devices 25, 60 shown in FIGS. 4 and 7, respectively, are characterized by a first gate electrode (not shown) within the electrolyte solution (not shown) that contacts the sensing area of the device in addition to a back gate that can control the current in a semiconductor channel. Instead of measuring the threshold voltage shift of the top transistor, as in a single-gate device, the threshold voltage of the bottom transistor is measured. The threshold voltage shift of the bottom transistor can be much greater than that of the top transistor, thereby increasing sensitivity compared to single-gate devices. Both double-gated and single-gated devices can be employed for detecting changes in pH as well as the capture of charged biomolecules that may be present in the electrolyte solution.

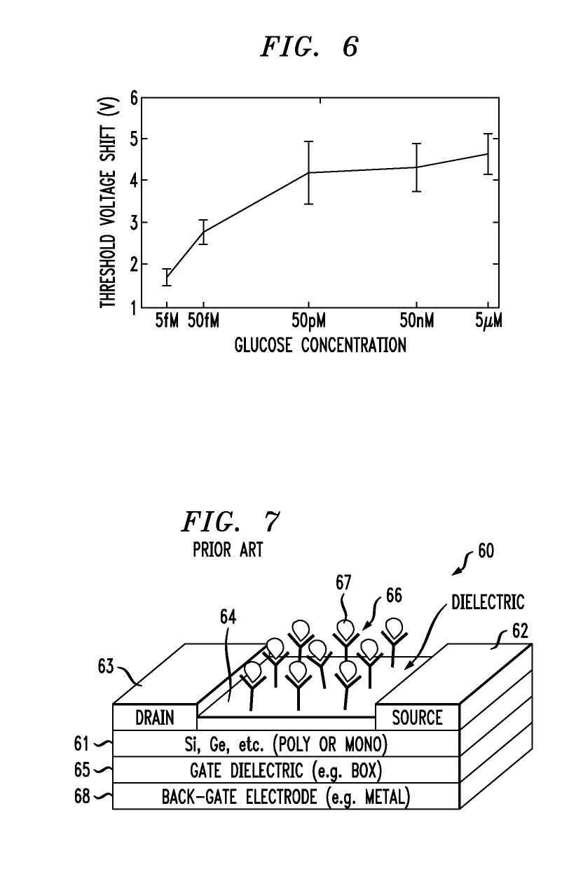

The effectiveness of a double-gated device as described with reference to FIG. 4 is shown by the graph provided in FIG. 6, which shows threshold voltage shift of the bottom transistor as a function of glucose concentration. The double-gated device includes a semiconductor-on-insulator (SOI) substrate including a crystalline silicon layer that adjoins a buried oxide layer. The silicon layer of the device has a thickness of thirty-two nanometers and includes n-type impurities, the doping level being about 5×10¹⁷ cm⁻³. The buried oxide layer is one hundred forty nanometers (140 nm) in thickness. The source/drain regions include a metal layer on n+ silicon. The passivation layer of the device is an organic monolayer of a long-chain alcohol (1-dodecanol). The monolayer is subject to epoxidation followed by causing the formation of terminal boronic acid groups. The threshold voltage shift (back-gate referred) was measured as a function of glucose concentration exposed to the front (functionalized) surface of the device. High sensitivity was achieved even though the base devices were not optimized.

Hybrid double-gated ISFETs as described with respect to FIG. 4 provide significant advantages over conventional double-gated ISFETs, such as shown in FIG. 7. To the first order, for both types of structures: ΔV_{T,back}=ΔV_{T,front}×C_{eff,front}/C_{ox,back}. For a conventional double-gate ISFET, such as that shown in FIG. 7: C_{eff,front}=C_{ox,front} ∥C_{bulk,Si}∥C_{bio} where C_{bio} represents the combined effects of the functionalization layer, the electrolyte, and associated materials. For a hybrid double-gate ISFET, such as described with respect to FIG. 4, C_{eff,front}=C_{bulk,Si}∥C_{bio}. Since C_{ox,front} is eliminated in the hybrid structure, the “signal” can fundamentally increase. Moreover, the 1/f “noise” associated with the top dielectric layer is eliminated. To the first order, a non-faradic electrode/electrolyte contact (e.g. reverse biased junction) is noise-free. Accordingly, the hybrid double-gate ISFET biosensor has both signal and noise advantages compared to conventional devices. With respect to the double-gated structure, if the ratios of the capacitances identified in the above equations are chosen appropriately, the threshold voltage shift of the bottom transistor can be much larger than that of the top transistor, thereby increasing the sensitivity. Accordingly, if the threshold voltage shift of the top transistor is below the detection limit, the appropriate capacitance ratio can provide a back threshold voltage shift large enough to bring it above the detection limit.

Given the discussion thus far and with reference to the exemplary embodiments discussed above and the drawings, it will be appreciated that, in general terms, an exemplary biosensor provided in accordance with a first aspect includes a doped inorganic semiconductor layer 10 including a channel region and source and drain regions 18, 14 operatively associated with the channel region. An organic passivation layer 12 directly contacts a top surface of the channel region of the doped inorganic semiconductor layer. A functionalization layer 16 including bio-sensing material is bound to the organic passivation layer. In some embodiments, the biosensor further includes a gate dielectric layer 23 on a bottom surface of the channel region of the doped inorganic semiconductor layer and a back gate electrode 22 adjoining the gate dielectric layer. The organic passivation layer is a self-assembled monolayer in one or more embodiments which may consist essentially of a long-chain alcohol or thiol.

An exemplary method for fabricating a hybrid organic/inorganic biosensor includes obtaining a obtaining a substrate including a doped inorganic semiconductor layer 10 having a channel region including a top surface and forming source and drain regions 18, 14 on the substrate. An organic passivation layer is formed directly on the top surface of the channel region of the doped inorganic semiconductor layer and a functionalization layer including bio-sensing material is formed on the organic passivation layer. In some embodiments, the step of forming the organic passivation layer further includes forming a self-assembled monolayer of an organic material directly on the top surface of the channel region. The method may further include epoxidizing the self-assembled monolayer. The top surface of the channel region is a hydrogenated surface in one or more embodiments that can be obtained by subjecting the substrate to treatment with hydrofluoric acid. FIGS. 5A-5C show an exemplary process for self- assembly and functionalization of silicon substrates for biosensors.

An exemplary method of using a hybrid organic/inorganic biosensor includes obtaining a biosensor including a doped inorganic semiconductor layer having a channel region, source and drain regions operatively associated with the channel region of the doped inorganic semiconductor layer, an organic passivation layer directly contacting a top surface of the channel region of the doped inorganic semiconductor layer, and a functionalization layer including bio-sensing material bound to the organic passivation layer. The method further includes contacting the functionalization layer with an electrolyte, applying a voltage potential to a gate electrode within the electrolyte, and detecting a shift in threshold voltage of the biosensor. If a double-gated biosensor is employed, the threshold voltage shift of the bottom transistor is detected.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof Terms such as “above”, “below”, “top” and “bottom” are generally employed to indicate relative positions as opposed to relative elevations unless otherwise indicated. It should also be noted that, in some alternative implementations, the steps of the exemplary methods may occur out of the order noted in the figures. For example, two steps shown in succession may, in fact, be executed substantially concurrently, or certain steps may sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A biosensor comprising:
a doped inorganic semiconductor layer including a channel region;
source and drain regions operatively associated with the channel region of the doped inorganic semiconductor layer;
an organic passivation layer directly contacting a top surface of the channel region of the doped inorganic semiconductor layer, and
a functionalization layer including bio-sensing material bound to the organic passivation layer.

2. The biosensor of claim 1, further including a gate dielectric layer on a bottom surface of the channel region of the doped inorganic semiconductor layer and a gate electrode adjoining the gate dielectric layer.

3. The biosensor of claim 2, wherein the doped inorganic semiconductor layer comprises an n-type crystalline silicon layer and the top surface is hydrogenated.

4. The biosensor of claim 3, wherein the organic passivation layer is a self-assembled monolayer bonded to the hydrogenated top surface.

5. The biosensor of claim 4, wherein the gate dielectric layer is a buried oxide layer.

6. The biosensor of claim 1, wherein the organic passivation layer is a self-assembled monolayer.

7. The biosensor of claim 6, wherein the self-assembled monolayer consists essentially of a long-chain alcohol or thiol.

8. The biosensor of claim 6, wherein the functionalization layer is attached to the organic passivation layer by a reaction with an epoxy group.

9. The biosensor of claim 8, wherein the doped inorganic semiconductor layer comprises an n-type crystalline layer.

10. A method comprising:
obtaining a substrate including a doped inorganic semiconductor layer having a channel region including a top surface;
forming source and drain regions on the substrate;
forming an organic passivation layer directly contacting the top surface of the channel region of the doped inorganic semiconductor layer, and
forming a functionalization layer including bio-sensing material on the organic passivation layer.

11. The method of claim 10, wherein the substrate further includes an electrically insulating layer adjoining a bottom surface of the substrate and a back gate electrode adjoining the electrically insulating layer.

12. The method of claim 10, wherein the step of forming the organic passivation layer further includes forming a self-assembled monolayer of an organic material directly on the top surface of the channel region.

13. The method of claim 12, wherein the step of obtaining the substrate further includes forming the top surface of the channel region as a hydrogenated surface.

14. The method of claim 13, further including the step of epoxidizing the self-assembled monolayer.

15. The method of claim 10, further including the step of contacting the functionalization layer with an electrolyte, positioning a second gate electrode within the electrolyte, and applying a voltage potential to the second gate electrode within the electrolyte.

16. A method comprising:
obtaining a biosensor including:
a doped inorganic semiconductor layer including a channel region;
source and drain regions operatively associated with the channel region of the doped inorganic semiconductor layer;
an organic passivation layer directly contacting a top surface of the channel region of the doped inorganic semiconductor layer, and
a functionalization layer including bio-sensing material bound to the organic passivation layer;
contacting the functionalization layer with an electrolyte;
applying a voltage potential to a gate electrode within the electrolyte, and
detecting a shift in threshold voltage of the biosensor.

17. The method of claim 16, wherein the biosensor further includes a back gate electrode and a gate dielectric layer between the channel region of the doped inorganic semiconductor layer and the back gate electrode.

18. The method of claim 16, wherein the organic passivation layer is a self-assembled monolayer.

19. The method of claim 18, wherein the self-assembled monolayer consists essentially of a long-chain alcohol or thiol.

20. The method of claim 17, wherein the functionalization layer is comprised of one of boronic acid, glucose oxidase, and crown ether.
